(19) United States
(12) Patent Application Publication
(10) Pub. No.: US 2020/0025601 A1
(43) Pub. Date: Jan. 23, 2020

(54) MEASURING CELL

(71) Applicant: ADVANCED WAVE SENSORS, S.L., Paterna (Valencia) (ES)

(72) Inventors: Antonio ARNAU VIVES, Paterna (Valencia) (ES); Yolanda JIMÉNEZ JIMÉNEZ, Paterna (Valencia) (ES); Pablo GARCÍA MOLLA, Paterna (Valencia) (ES); José Vicente GARCÍA NARBÓN, Paterna (Valencia) (ES); Román FERNÁNDEZ DÍAZ, Paterna (Valencia) (ES)

(73) Assignee: ADVANCED WAVE SENSORS, S.L., Paterna (Valencia) (ES)

(21) Appl. No.: 16/484,602

(22) PCT Filed: Feb. 13, 2017
(86) PCT No.: PCT/ES2017/070083

§ 371 Date: Aug. 8, 2019

(51) Int. Cl. G01G 3/13; G01G 3/16

(52) U.S. Cl. CPC G01G 3/13; G01G 3/165

(57) ABSTRACT

The invention relates to a cell for measuring a piezoelectric resonator, which has a first casing body and a second casing body, and a quartz resonator configured as a wafer having metal layers on both sides as electric contact surfaces, the first casing body having coupling features and the second casing body having coupling slots, the coupling features being configured to be assembled in the coupling slots when the measuring cell is in a working position, such that the first casing body is assembled in the second casing body when pressure is exerted on the first casing body until the surface of the lower end of the first body makes physical contact with the upper surface of the second casing body and, subsequently, the first casing body is rotated to one side of the axis of symmetry of the measuring cell.

### OBJECT OF THE INVENTION

This invention relates to a measurement cell for a piezoelectric resonating sensor that is used as a piezoelectric microbalance in a fluid medium.

### STATE OF THE ART

A device for weighing a mass deposited on a face of a quartz crystal wafer of a quartz crystal microbalance (QCM) is known in the state of the art from the patent application EP2447683A1, included herein by reference.

The quartz crystal microbalance QCM measures the mass deposited on a face of a quartz crystal by altering the internal natural oscillation frequency of a quartz crystal. The correlation between the mass deposited on the quartz crystal wafer and the oscillation of the natural frequency of the quartz crystal is defined by the Sauerbrey equation.

The cell for a QCM microbalance comprises a first casing body and a second casing body that are assembled together and can be disassembled such that the QCM microbalance can operate in a vacuum environment or in a fluid environment such as a liquid or a gas.

The first casing body comprises an inlet port for directing the working fluid towards the upper face of the quartz crystal wafer in order for the quartz crystal to come into contact with the working fluid.

The second casing body comprises a supporting structure for receiving the quartz crystal and a container for also receiving an electronic excitation circuit that supplies, an electrical voltage to the quartz crystal through working terminals electrically connected to working electrodes arranged in the back or lower side of the quartz crystal. When a high-frequency modulated electric field is applied to the quartz crystal, a measurable mechanical vibration is produced whose frequency varies depending on the mass deposited on the upper face of the quartz crystal.

When the upper face of the quartz crystal is in contact with a working liquid, it is necessary to prevent the working liquid from reaching the electrical measuring chamber of the second casing body. Therefore, the second casing body comprises a means for sealing to isolate the wet zone or contact zone of the quartz crystal with a working fluid medium from a dry zone, where an electronic excitation circuit of the quartz crystal is located, and also the other side of the sensor.

Also, the means of sealing must endeavour to uniformly distribute applied clamping forces that are applied to mechanically mount the first casing body and the second casing body in the working position of the piezoelectric microbalance.

To ensure the repeatability of the measurements made by the piezoelectric microbalance, the means of sealing must be easily removable as they must be changed after several working cycles of the piezoelectric microbalance.

### SUMMARY

The present invention aims to resolve one or more of the drawbacks outlined above by means of a measurement cell of ;a piezoelectric resonating sensor as claimed in the claims.

A measurement cell of a piezoelectric resonator or piezoelectric quartz crystal resonator comprising a first casing body and a second casing body wherein the resonator includes at least two metal electrical car electrodes, wherein the first casing body comprises coupling ridges and the second casing body comprises engaging slots, configured so that the coupling ridges can be assembled inside the engaging slots when the measurement cell is in working position. The electrical contacts can be located on the same surface of the resonator or distributed proportionally on both surfaces of the resonator.

The first casing body is assembled in the second casing body when a pressing force is exerted on the first casing body until the lower surface of the first casing body makes physical contact with the upper surface of the second casing body and then a rotation of the first casing body in one direction around the axis of symmetry of the measuring cell is performed.

The first casing body performs a rotation equal to or greater than 30°; preferably, a rotation between 45° and 90°, a rotation of a quarter of a turn.

The measurement cell comprises a piezoelectric resonator comprising at least two electrical contact electrodes one arranged on the lower face of the resonator and another on the upper face but configured in such a way that they are accessible from the underside of the resonator to make electrical contact with at least two electrical connection electrodes distributed on a supporting structure.

The supporting structure has at least two through-holes ire which the electrical connection electrodes are embedded, protruding from the upper and lower surface of the supporting structure.

In addition, the supporting structure comprises a plurality of blind-holes distributed in a regular manner and concentrically to the axis of symmetry of the measurement cell over the lower surface of the supporting structure, so that a plurality of electrical connection terminals can be inserted into the plurality of blind-holes.

Two electrical connection terminals make electrical contact with the electrical connection electrodes, respectively.

The electrical connection terminals comprise springs providing a vertical displacement, according to the axis of symmetry of the measuring cell, to the supporting structure in order to limit the pressure on the resonator when the measurement cell is in working position.

The plurality of electrical connection terminals are inserted under pressure into a plurality of through-holes distributed in a regular manner in a distributor element that keeps the electrical connection terminals separated from one another.

Therefore, the electrical contact electrode establishes electrical contact with an electronic interface through the electrical connection electrodes and the electrical connection terminals.

The measurement, cell has, alternatively, a supporting structure with a shape and dimensions that prevent it from being rotated according to the axis of symmetry of the measuring cell.

In summary, the resonator is pressed both by the lower end of the first casing body and by the supporting structure by the pressure exerted by the electrical connection terminals through the supporting structure. The resonator is of the piezoelectric resonator type, a piezoelectric quartz crystal resonator or similar.

### BRIEF DESCRIPTION OF THE FIGURES

A more detailed explanation is given in the following description and is based on the attached figures:

FIG. 1 shows an exploded perspective view of a measurement cell of a piezoelectric quartz crystal resonator.

FIG. 2 shows a perspective view of the measurement cell in the working position.

FIG. 3 shows a perspective view of a second casing body of the measurement cell.

FIG. 4 shows a perspective view of the second casing body of an alternative measurement cell where a resonator is integrated into a supporting structure forming a single floating element and where the second casing body includes regularly distributed through-holes in which are inserted a set of electrical connection terminals.

### DESCRIPTION

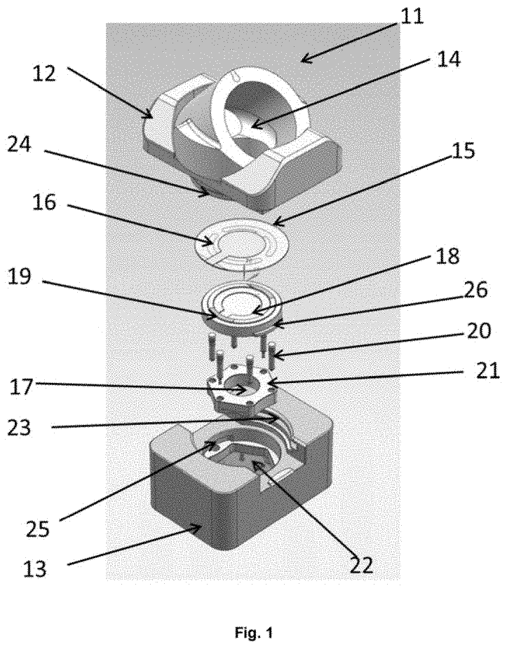

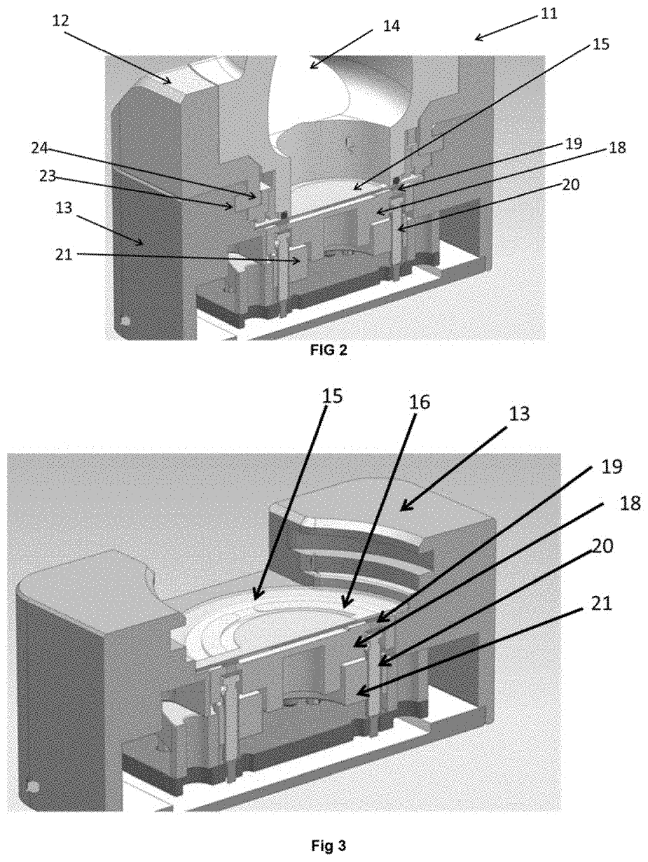

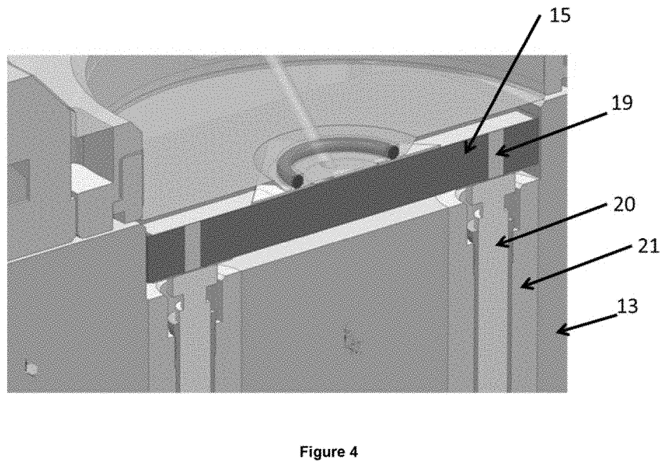

FIGS. 1 to 4 show a measurement cell 11 of a sensor based on a piezoelectric resonator comprising a first casing body 12 and a second casing body 13 coupled so as to make possible their disassembly from a closed working position to an open working position and vice versa. The first casing body 12 has coupling ridges 24 to be retained in corresponding engaging slots 23 included in the second casing body when the measurement cell 11 is in the working position.

For example, in order to open the measurement cell 11, a rotation of the first casing body 12 must be performed in one direction along an axis of symmetry of the measurement cell 11 and then a vertical movement of the first casing body 12 performed along the same axis of symmetry.

Similarly, in order to assemble the measurement cell 11, the first and second casing bodies 12, 13 must be coupled by inserting the first casing body 12 into the second casing body 13 and then the first casing body 12 rotated in one direction around the axis of symmetry of the measurement cell 11,

That is to say, in order to assemble or disassemble the measurement cell 11, a vertical movement in accordance with the axis of symmetry of the measurement cell 11 and a rotational movement of the first casing body 12 on the second casing body 13 around the same axis of symmetry must be coordinated.

The second casing body 13 accommodates in its interior, a structure of superposed layers or a sandwich of several layers, in descending order from the upper end of the second casing body 13, in contact with the lower end of the first casing body 12, towards the distal end of the second casing body 13, a resonator 15 comprising at least one pair of electrical contact electrodes 16, wherein a first electrical contact electrode is disposed on the upper face of the resonator 15 and a second contact electrode is arranged on the underside of the resonator 15 in such a way that both contacts are accessible from the underside of the quartz resonator 15. Alternatively, the electrical contact electrodes 16 may be located on the same surface of the resonator 15. The upper face of the resonator 15 is configured to receive a working fluid guided from an inlet mouth 14 arranged in the first casing body 12.

The resonator 15 is of the piezoelectric resonator type, a piezoelectric quartz crystal resonator or similar.

A seal is placed between the first casing body 12 and the resonator 15 to ensure sealing between both parts.

The two electric contact electrodes 16 are planar and concentric in the form of an annular portion and are positioned in diametrically opposite positions of the lower face of the resonator 15.

The resonator 15 is located on the upper surface of a floating supporting structure 18, which comprises at least two concentric electrical connection electrodes 19 in the form of a ring portion and are placed in diametrically opposite positions on the upper surface of the floating supporting structure 18 for maintaining a continuous electrical connection with the electrical contact electrodes 16 of the resonator 15.

The electrical connection electrodes 19 are embedded in respective through-holes of the flat disk of the supporting structure 18 so that they protrude from the upper and lower surfaces of the disk; that is, the electrical connection electrodes 19 protrude from both sides of the disk of the supporting structure 18.

The supporting structure 18 rests on the upper ends of a set of electrical connection terminals 20 distributed in corresponding through-holes regularly distributed on a distributor element 21.

The floating supporting structure 18 has a regular shape adapted to receive on itself the resonator 15, for example, in the form of a fiat disk with a trunk in the form of a hollow column, so that the fiat disk has at least two protruding projections 26, in the form of a semi-circular portion arranged on diametrically opposite positions in proximity to the lower surface of the supporting structure 18.

The supporting structure 18 comprises a plurality of blind-holes distributed in a regular manner and concentrically to the trunk of the supporting structure 18 on the lower surface of the disc of the same structure 18, so that the set of electrical connection terminals 20 can be inserted into the plurality of blind-holes to fix the position of the supporting structure 18 with respect to the distributor 21.

The lower surface of the supporting structure 18 rests on the set of electrical connection terminals 20 on springs, being located in a predetermined position determined by the plurality of through-holes of the distributor element 21.

The through-holes of the distributor 21 have a predetermined bore diameter so that the connection terminals 20 are embedded with pressure into the holes of the distributor 21 so that the connection terminals 20 remain at a predetermined height on the upper surface of the distributor 21.

In turn, the trunk of the supporting structure 18 is embedded in a cylindrical through-hole 17 of the distributor 21. The outer surface of the distributor 21 has a different shape from a cylindrical shape, for example, rectangular and/or parallelepiped to fix the distributor 21 within a corresponding hollow 22 of the second casing body 13.

The floating supporting structure 18 can be moved vertically with respect to the axis of symmetry of the measurement cell 11 under pressure exerted by the first casing body 12 when it is mechanically coupled to the second casing body 13, so that the first casing body 12 exerts a controlled, constant and uniformly distributed pressure on the resonator 15.

The vertical displacement of the supporting structure 18 is supplied by the springs of the electrical connection terminals 20. A controlled pressure reduces the drift in the response of the resonator 15 causing the baseline to be reached in a much shorter time.

Once the quartz crystal resonator 15 is deposited on the upper surface of the supporting structure 18, the concentric electrical contact electrodes 16 establish electrical contact with the concentric electrical connection electrodes 19 embedded in the supporting structure 18.

In summary, the first casing body 12, once mechanically coupled to the second casing body 13, exerts a pressure on the resonator 15, which, in turn, transfers the pressure onto the supporting structure 18 which, in turn, compresses the springs of the connection terminals 20, the vertical displacement of the supporting structure 18 being guided by the through-hole of the second casing body 13.

The projections 26 that serve to facilitate the assembly of the supporting structure 18 within the second casing body 13 and, furthermore, serve as a guide for causing the supporting structure 18, perform an upward or downward movement during assembly or disassembly of the measuring cell 11.

The projections 26, arranged in opposition to one another, prevent the supporting structure 18 from moving out of its mounting position in the second casing body 13 since they are respectively inserted into diametrically opposed slots 25 on the inner surface of the second casing body 13. They also prevent the rotation of the supporting structure 18 around its axis of symmetry during the assembly and disassembly process of the measurement cell 11.

The supporting structure 18 is guided vertically by the dimensions of the slots 25. The supporting structure 18 is raised slightly above the lower surface of the slots 25. The clearance or height of the slots 25 is sufficient so that when mechanically engaging the first and second casing bodies (12, 13), the supporting structure 18 together with the resonator 15 can be moved vertically towards the lower end of the second casing body 13. In this sense, the measurements and mechanical displacements are calculated accurately.

Alternatively, the springs of the electrical connection terminals 20 control the vertical displacement of the resonator 15 so that the displacement and pressure exerted on the resonator 15 reduces the drift in the response of the resonator 15 on the measurement cell 11.

The concentric electrical connection electrodes 19 embedded in the supporting structure 18 establish electrical contact with the corresponding connection terminals 20 when the supporting structure is arranged on the distributor 21.

The connection terminals 20, which establish electrical contact with the concentric electrical connection electrodes 19, also establish electrical contact with an electronic interface for transferring electrical signals to an internal and/or external electrical circuit of the measurement cell 11. The internal circuit is located in an enclosure of the second casing body 13.

The supporting structure 18 has limited vertical displacement along the axis of symmetry by the height of the slot 25 of the second casing body 13.

The arrangement of supporting structure 18 and electrical connection terminals 20 functions as a vertically movable spacer along the axis of symmetry of the measuring cell 11 under pressure. In addition, the arrangement of the supporting structure 18 and electrical connection terminals 20 establishes electrical contact between the electrical contact electrodes 16 of the resonator 15 and the electronic interface.

The upper face of the electrical connection electrode 19 is opposite to a free face of the electrical contact electrode 16. And the lower face of the electrical connection electrode 19 is opposite to a free end of an electrical connection terminal 20.

The assembly formed by the supporting structure and the electrical connection terminals 18, 20 are configured as a vertically movable body according to the axis of symmetry of the measurement cell 11, in order to evenly distribute the force applied during the assembly and disassembly of the measurement cell 11, keeping the resonator 15 in the target position when in any position of the measurement cell 11, thus avoiding any deterioration of the quartz crystal resonator 15.

In the working position of the measurement cell 11, that is, the first casing body 12 mechanically coupled to the second casing body 13, the resonator 15 is sealed by the pressure between the lower part of the first casing body 12 and the supporting structure 18, with the quartz crystal resonator 15 remaining between them in the form of a sandwich.

Therefore, the sealing of the measurement cell 11 avoids the use of clamping screws, so that the reproducibility in the positioning and in the pressure performed on the resonator 15 is high, unlike the use of clamping screws where the pressure exerted depends on the tightening force performed by the user. This is undesirable since it reduces reproducibility in consecutive measurements when the cell 11 is disassembled and reassembled.

In summary, the electric contact electrodes 16 establish electrical contact with the electronic interface through the electrical connection electrodes 19 and the electrical connection terminals 20.

1. Measurement cell of a piezoelectric resonator (15) comprising a first casing body (12) and a second casing body (13) wherein the resonator (15) includes at least two electrical contact electrodes (16), characterized in that the first casing body (12) comprises coupling ridges (24) and the second casing body comprises engaging grooves (23) wherein the coupling ridges (24) are configured to be assembled into the engaging grooves (23) when the measurement cell (11) is in working position.

2. Measurement cell according to claim 1 characterized in that the first casing body (12) is assembled in the second casing body (13) when a pressing force is exerted on the first casing body (12) until the surface of the lower end of the first body (12) makes physical contact with the resonator (15) and then a rotation of the first casing body (12) in one direction around the axis of symmetry of the measuring cell (11) is performed.

3. Measurement cell according to claim 2 characterized in that the first casing body (12) performs a rotation equal to or greater than 30°.

4. Measurement cell according to claim 2 characterized in that the first casing body (12) performs a rotation of between 45° and 90°.

5. Measurement cell according to claim 1 characterized in that the resonator (15) comprises at least two electrical contact electrodes (16) configured to make electrical contact with at least two electrical connection electrodes (19) distributed on a supporting structure (18).

6. Measurement cell according to claim 5 characterized in that the supporting structure (18) has at least two through-holes in which the electrical connection electrodes (19) are respectively embedded protruding from the upper and lower surfaces of the supporting structure (18).

7. Measurement cell according to claim 5 characterized in that the supporting structure (18) comprises a plurality of blind-holes distributed in a regular manner and concentrically to the axis of symmetry of the measurement cell (11) by the lower surface of the supporting structure (18), so that a plurality of electrical connection terminals (20) can be inserted into the plurality of blind-holes.

8. Measurement cell according to claim 5 characterized in that the supporting structure (18) has a shape and dimensions that prevent it from being rotated around the axis of symmetry of the measurement cell (11).

9. Measurement cell according to claim 7 characterized in that at least two electrical connection terminals (20) respectively make electrical contact with the electrical connection electrodes (19).

10. Measurement cell according to claim 7 characterized in that the electrical connection terminals (20) comprise springs providing a vertical displacement, according to the axis of symmetry of the measurement cell (11), to the supporting structure (18) to limit the pressure on the resonator (15) when the measurement cell (11) is in working position.

11. Measurement cell according to claim 7 characterized in that the plurality of electrical connection terminals (20) are inserted under pressure into a plurality of through-holes distributed in a regular manner in a distributor element (21) that keep the electrical connection terminals (20) separated from each other.

12. Measurement cell according to claim 7, characterized in that the electrical contact electrode (16) establishes electrical contact with an electronic interface through the electrical connection electrodes (19) and the electrical connection terminals (20).

13. Measurement cell according to claim 5, characterized in that the resonator (15) is pressed both by the lower end of the first casing body (12) and by the supporting structure (18) by the pressure exerted by the electrical connection terminals (20) through the supporting structure (18).

14. Measurement cell according to any of the preceding claims characterized in that the resonator (15) is of the piezoelectric resonator type (15), a piezoelectric quartz crystal resonator or similar.

15. Measurement cell according to claim 14, characterized in that the electrical contacts (16) are located on a surface of the resonator (15).

16. Measurement cell according to claim 14, characterized in that the electrical contacts (16) are located on different surfaces of the resonator (15).
